(19) United States
(12) Patent Application Publication
(10) Pub. No.: US 2012/0163169 A1
(43) Pub. Date: Jun. 28, 2012

(54) OVERLOAD CONTROL APPARATUS AND METHOD FOR MACHINE TYPE COMMUNICATION SERVICE AND WIRELESS COMMUNICATION SYSTEM PROVIDING MACHINE TYPE COMMUNICATION SERVICE

(75) Inventors: Mi Jeong YANG, Daejeon (KR); Soon Yong LIM, Daejeon (KR); Ae Soon PARK, Daejeon (KR)

(73) Assignee: Electronics and Telecommunications Research Institute, Daejeon (KR)

(21) Appl. No.: 13/333,285

(22) Filed: Dec. 21, 2011

(30) Foreign Application Priority Data
Dec. 22, 2010 (KR) 10-2010-0132113

(51) Int. Cl. H04W 74/08; H04W 28/02

(52) U.S. Cl. 370/230; 370/329

(57) ABSTRACT

Provided are an overload control apparatus and method for a machine type communication (MTC) service. The overload control method includes, when an overload state has occurred, including an overload indicator (OI) in a MAC subheader in a random access response to be transmitted to a terminal and transmitting the random access response, before an MTC device wanting to perform a random access procedure transmits a random access preamble to the base station, searching for a random access response transmitted from the base station, when the transmitted random access response is searched for, peeking at the random access response and receiving it, and when it is determined that an OI is included in the random access response, waiting, at the MTC device, for a predetermined delay time and transmitting the random access preamble for performing the random access procedure to the base station.

### CLAIM FOR PRIORITY

This application claims priority to Korean Patent Application No. 10-2010-0132113 filed on Dec. 22, 2010 in the Korean Intellectual Property Office (KIPO), the entire contents of which are hereby incorporated by reference.

### BACKGROUND

1. Technical Field

Example embodiments of the present invention relate in general to control of an overload state caused by a machine type communication (MTC) service in a Third Generation Partnership Project (3GPP) Long Term Evolution (LTE)-Advanced system, and more particularly, to an overload control apparatus and method for an MTC service in a wireless communication network, and a wireless communication system providing an MTC service.

2. Related Art

MTC or machine-to-machine (M2M) communication is a form of data communication which involves one or more entities that do not necessarily need human interaction. A service optimized for MTC differs from a service optimized for human-to-human communication. In comparison with a current mobile network communication service, the MTC service can be characterized by a) several market scenarios, b) data communications, c) lower cost and less effort, d) a potentially very large number of communicating terminals, e) a wide service area, and f) very low traffic per terminal.

MTC may be implemented in various forms of service, for example, smart metering, tracking and tracing, remote maintenance and control, and e-health.

Lately, 3GPP has also been working on MTC standardization for intelligent communication between a human and an object and between objects. For various types of MTC applications having main functions of smart metering, remote control, etc., a huge number of MTC devices are disposed and managed.

In 3GPP LTE systems, either of an MTC device and general terminal is treated as one user equipment (UE) and needs to be individually registered in an LTE network. The disposition of multiple MTC devices causes scheduling competition for channel allocation, to exhaustion of radio resources, overload resulting from signal generation, and so on, thereby exerting a bad influence on existing general terminals.

Basically, a terminal of a 3GPP LTE-Advanced system should receive uplink timing information from a base station to perform synchronization, or should perform a random access procedure to control and set power for initial uplink transmission or transmit a user message.

With an emphasis put on minimization of the adverse effect caused by the disposition of MTC devices, 3GPP has been working on standardization. However, in an overload state of a network, intensive random access attempts and acceptances made by MTC devices worsen the overload state, resulting in a deterioration in service for a terminal in use and an access limit of a general terminal.

Thus, an efficient method is required to recognize an overload state of a network and control intensive random access of MTC devices on the basis of the recognition. To this end, 3GPP Service and System Aspects 2 (SA2) and Radio Access Network 2 (RAN2) have been working on standardization, but no clear solution has been proposed yet.

### SUMMARY

Accordingly, example embodiments of the present invention are provided to substantially obviate one or more problems due to limitations and disadvantages of the related art.

Example embodiments of the present invention provide an overload control apparatus and method for a machine type communication (MTC) service that apply an overload state of a network to a random access procedure of an MTC device in a mobile communication system based on Third Generation Partnership Project (3GPP) Long Term Evolution (MTE)-Advanced.

In some example embodiments, an overload control method for an MTC service in a wireless communication network includes: when it is notified from a network that an overload state has occurred, including an overload indicator (OI) in a media access control (MAC) subheader in a random access response message to be transmitted to a terminal by a base station, and transmitting the random access response message; before an MTC device wanting to perform a random access procedure transmits a random access preamble to the base station, searching for a random access response message transmitted from the base station, and when the transmitted random access response message is searched for, peeking at the random access response message and receiving the random access response message; and when it is determined that an OI is included in the peeked and received random access response message, waiting, at the MTC device, for a delay time determined based on the OI and transmitting the random access preamble for performing the random access procedure to the base station.

The delay time may increase as an overload level indicated by the OI increases.

The MAC subheader may further include a backoff indicator (BI), and delay time may increase in proportion to an overload level indicated by the OI and a backoff value indicated by the BI.

A general terminal receiving the random access response message from the base station may perform a common random access procedure inespective of the OI included in the MAC subheader in the random access response message.

The overload control method may further include, when the base station is notified from the network that the overload state has been finished, removing, at the base station, the OI from the MAC subheader in the random access response message to be transmitted to the terminal, and transmitting the random access response message.

The base station may configure the OI using reserved bits in the MAC subheader when the network is in the overload state, and maintain the reserved bits in the MAC subheader in an original state when the network is not in the overload state.

When the network is in the overload state, the MAC subheader may include the OI and a BI.

In other example embodiments, a wireless communication system includes: a base station configured to, when notified from a network that an overload state has occurred, include an OI in a MAC subheader in a random access response message to be transmitted to a terminal and transmit the random access response message; and an MTC device configured to, before transmitting a random access preamble to the base station to perform a random access procedure, search for a random access response message transmitted from the base station, when the transmitted random access response message is searched for, peek at the random access response message and receive the random access response message, and when it is determined that an OI is included in the received random access response message, wait for a predetermined delay time and transmit the random access preamble for performing the random access procedure to the base station.

The wireless communication system may further include a general terminal configured to receive the random access response message from the base station, and perform a common random access procedure inespective of the OI included in the MAC subheader in the random access response message.

In other example embodiments, an overload control apparatus for an MTC service includes an OI in a MAC subheader in a random access response message to be transmitted to a terminal and transmit the random access response message when notified from a network that an overload state has occurred, and removes the OI from the MAC subheader in the random access response message to be transmitted to the terminal and transmits the random access response message when notified from the network that the overload state has been finished.

The overload control apparatus may configure the OI using reserved bits in the MAC subheader when the network is in the overload state, and maintain the reserved bits in the MAC subheader in an original state when the network is not in the overload state.

When the network is in the overload state, the MAC subheader may include the OI and a BI.

The overload control apparatus may be a base station.

In other example embodiments, an MTC device communicates with a base station for an MTC service, before transmitting a random access preamble to the base station to perform a random access procedure, searches for a random access response message transmitted from the base station, when a transmitted random access response message is searched for, peeks at the random access response message and receives the random access response message, and when it is determined that an OI is included in the received random access response message, waits for a predetermined delay time and transmits the random access preamble for performing the random access procedure to the base station.

### BRIEF DESCRIPTION OF DRAWINGS

Example embodiments of the present invention will become more apparent by describing in detail example embodiments of the present invention with reference to the accompanying drawings, in which:

FIG. 1 illustrates a random access procedure of a terminal in a Third Generation Partnership Project (3GPP) Long Term Evolution (LTE)-Advanced system;

FIG. 2 illustrates a random access procedure of a machine type communication (MTC) device according to an example embodiment of the present invention;

FIG. 3 is a flowchart illustrating operation of network components when an overload state of a network is cleared;

FIG. 4 shows a constitution of a media access control (MAC) subheader of a general random access response message;

FIG. 5 shows a constitution of a MAC subheader of a random access response message including an overload indicator (OI) according to an example embodiment of the present invention; and

FIG. 6 shows a whole constitution of a random access response message including a MAC subheader according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

The term “base station” used herein generally denotes a fixed point communicating with a terminal, and may be referred to as a Node-B, evolved Node-B (eNB), base transceiver system (BTS), access point (AP), and other terms.

Hereinafter, example embodiments of the present invention will be described in detail with reference to the appended drawings. To aid in understanding the present invention, like numbers refer to like elements throughout the description of the figures, and the description of the same component will not be reiterated.

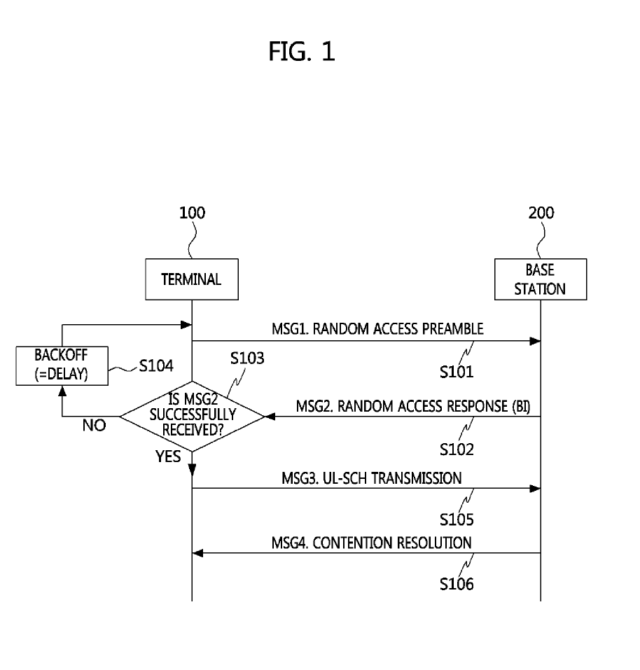

FIG. 1 illustrates a random access procedure of a terminal in a Third Generation Partnership Project (3GPP) Long Term Evolution (LTE)-Advanced system.

As a process for a terminal to be attached to a network, a random access procedure is performed in the cases of initial attachment, handover, scheduling request, uplink time synchronization, and so on. In other words, all terminals perform random access for initial attachment and data transmission.

Random access procedures may be classified into a contention-based access procedure and a non-contention-based access procedure. The contention-based access procedure will be described with reference to FIG. 1. In the contention-based random access to procedure, a random one of a plurality of random access preambles used in common is selected and used, which may result in collision with other terminals.

Referring to the random access procedure illustrated in FIG. 1, first, a terminal 100 randomly selects a random access preamble MSG1 using random access-related system information that has been received from a base station 200 in advance, and transmits the selected preamble MSG1 to the base station 200 (S101).

The base station 200 receives the preamble MSG1 from the terminal 100, and transmits a random access response message MSG2 to the terminal 100 (S102). Here, the random access response message MSG2 may include a backoff indicator (BI). When there is no BI, a backoff value is considered to be 0.

The terminal 100 receives the random access response message MSG2, and considers the corresponding random access to have failed when it is determined that content of the received random access response message MSG2 is not a response to the preamble MSG1 transmitted by the terminal 100 itself to the base station 200 (“No” in S103). When it is determined that the attempted random access has failed, the terminal 100 selects a backoff value based on the BI included in the random access response message MSG2 (S104). Then, the terminal 100 attempts attachment again according to the selected backoff value. In other words, transmission of the random access preamble MSG1 is repeatedly performed (S101).

When the terminal 100 successfully receives a response to the preamble MSG1 transmitted by the terminal 100 itself (“Yes” in S103), the terminal 100 transmits a scheduled uplink shared channel (UL-SCH) MSG3 including a terminal identifier (ID) to the base station 200 using radio resources allocated by the base station 200 (S105). The base station 200 receiving the UL-SCH MSG3 transmits a contention resolution message MSG4 as a response to the UL-SCH MSG3 (S106), and the random access procedure is completed when the terminal 100 receives the contention resolution message MSG4.

In other words, MSG1 to MSG4 need to be successfully exchanged in the random access procedure.

In a machine type communication (MTC) service, multiple random access procedures may be caused at the same time by many MTC devices due to unique characteristics of the MTC service. As mentioned above, a random access reattempt caused by unsuccessful random access results in a vicious cycle of concentration and failure of random access.

In a random access method according to an example embodiment of the present invention, an MTC device receives a random access response message MSG2 in which an overload state of a network has been reflected before a random access procedure begins (i.e., transmission of a random access preamble MSG1), and controls random access of the MTC device itself on the basis of an OI and BI included in the random access response message MSG2.

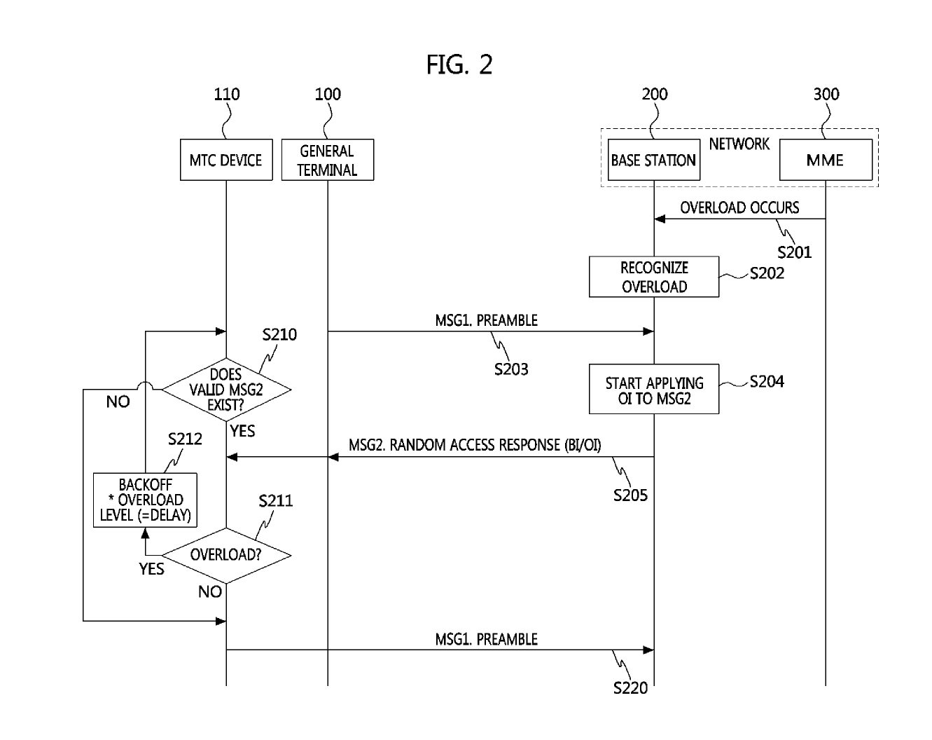

In this regard, the random access method according to an example embodiment of the present invention will be described in detail below with reference to FIG. 2.

FIG. 2 illustrates a random access procedure of an MTC device according to an example embodiment of the present invention.

As illustrated in FIG. 2, a random access procedure of an MTC device according to an example embodiment of the present invention may be applied to a mobile communication system, in particular, a 3GPP system, including a mobility management entity 300, a base station 300, at least one general terminal 100, and at least one MTC device 110.

Here, the MME 300 is a control node that processes signaling between a UE and a core network (CN). Main functions provided by the MME 300 include bearer management-related functions and connection management-related functions.

A procedure illustrated in FIG. 2 is based on the assumption that an overload state has occurred in a network (S201) and the base station 200 has been notified of the overload state by the MME 300 (S202).

In this situation, the general terminal 100 transmits a random access preamble MSG1 to for random access (S203). Since the base station 200 receiving the random access preamble MSG1 from the general terminal 100 has been notified of the network overload state through the MME 300, the base station 200 includes an OI in a MAC subheader in a random access response message MSG2 to be transmitted to the terminal 100 (S204) and transmits the random access response message (S205). Here, the random access response message transmitted by the base station 200 may include a BI and OI. This constitution, that is, the random access response message MSG2 including an OI in which the network overload state is reflected, is an important characteristic of the present invention.

The general terminal 100 receiving the random access response message MSG2 including the OI performs a general random access procedure in the same way as an existing procedure irrespective of OI bits designated as reserved bits included in the random access response message MSG2.

On the other hand, before attempting random access, the MTC device 110 first determines whether the random access response message MSG2 has been transmitted from the base station 200 due to random access caused by another terminal (S210).

The random access response message MSG2 is masked by a random access-radio network temporary identifier (RA-RNTI), and thus can be received by all terminals. An example embodiment of the present invention includes a random access pre-processing process in which an MTC device that has not attempted random access peeks at a random access response message transmitted to another general terminal using such a characteristic of a random access response message.

Pre-processing operations before the MTC device 110 transmits the random access response message MSG2 will be described in further detail below.

If a random access procedure is necessary, the MTC device 110 searches for a valid random access response message transmitted by the base station 200 for a predetermined delay time before transmission of the random access preamble MSG1 (S210).

When no valid random access response message MSG2 is searched for, it is assumed that no terminal is currently attempting a random access and there is a strong possibility of successful random access (“No” in S210). Thus, the MTC device 110 transmits the random access preamble MSG1 to the base station 200 to perform the random access procedure (S220).

On the other hand, when the valid random access response message MSG2 is searched for (“Yes” in S210), the MTC device 110 determines whether or not the random access response message MSG2 includes an OI (S211). When an OI is included in the random access response message (i.e., the network is in the overload state; “Yes” in S211), the MTC device 110 waits for a delay time which is obtained by meaningfully applying an OI value to a backoff value (e.g., a delay time may be set to “backoff value*N (overload level)”) (S212). After the delay time elapses, the MTC device 110 reattempts a process of peeking at the random access response message MSG2 (S210).

In other words, another important characteristic of the present invention is to use an OI value included in the random access response message MSG2 for dispersing random access of MTC devices.

When the valid random access response message MSG2 is searched for in the random access response message peeking process (S210) and no OI is in the random access response message MSG2 (i.e., the network is not in the overload state; “No” in S211), the MTC device 110 transmits the random access preamble MSG1 (S220), thereby performing the random access procedure.

Like a general terminal, the MTC device 110 performs a random access process after transmitting the random access preamble MSG1 in the same way as an existing random access procedure.

Next, operation performed when an overload state of a network is cleared will be described below.

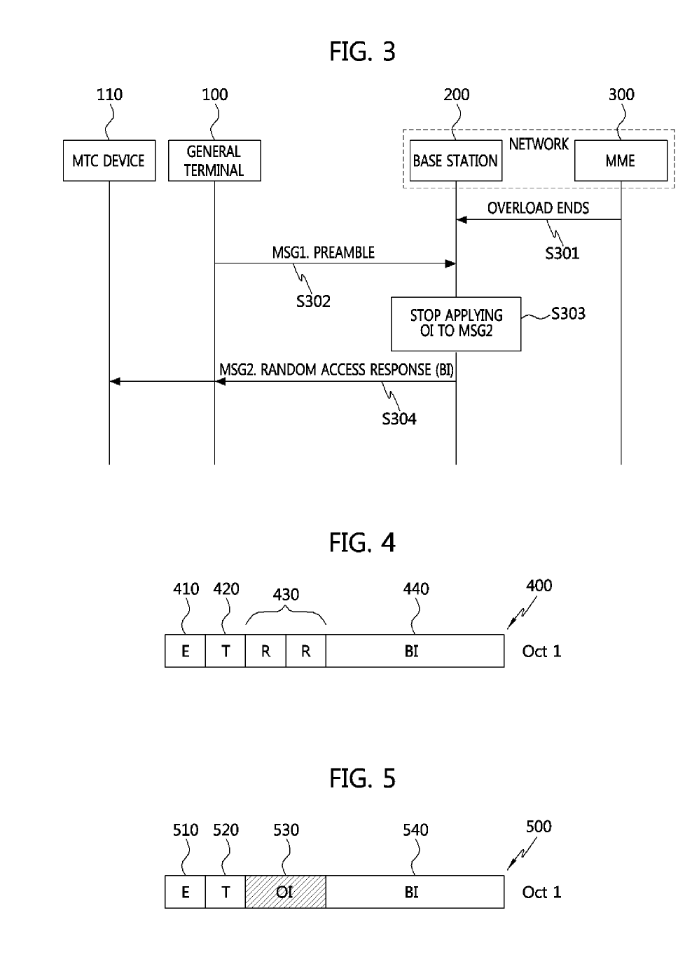

FIG. 3 is a flowchart illustrating operation of network components when an overload state of a network is cleared.

When an overload state occurs and then is cleared in a network (S301), a base station 200 receives a message indicating that the overload state has ended through an MME 300. In this situation, the base station 200 receiving a random access preamble MSG1 from a general terminal 100 (S302) stops applying an OI in response to the random access preamble MSG1 when configuring an access response message (S303).

In other words, reserved bits to be used as an OI are not used as an OI, which will be described in an example embodiment below. In this way, the base station 200 indirectly informs an MTC device 110 that the network is not in the overload state.

The base station 200 configures a random access response message as mentioned above, and transmits the configured random access response message to the MTC device 110 (S304). Here, the random access response message does not include an OI but only includes a BI.

When the overload state does not occur in a network as illustrated in FIG. 3, a general terminal and MTC device operate in the same way as in the overload state, so that operation of the general terminal and MTC device can be implemented uniformly.

FIG. 4 shows a constitution of a media access control (MAC) subheader of a general random access response message.

As shown in FIG. 4, a MAC subheader 400 of a random access response message may be composed of octet (8 bit) units, and has a variable length. In FIG. 4, one octet is shown as a reference for convenience.

The MAC subheader 400 of FIG. 4 includes an E field 410 of one bit, a T field 420 of one bit, a BI field 440 of four bits, and reserved (R) fields 430 of two bits. In general, such a structure is referred to as an E/T/R/R/BI structure.

Here, the E field 410 is an extension field indicating whether or not an additional field is in the MAC subheader 400. In other words, when the E field 410 is set to 1, there are follow-up E/T/random access preamble identifier (RAPID) fields. When the E field 410 is set to 0, MAC random access responses (RARs) or padding is started from the next byte.

The T field 420 is a type flag indicating whether or not the MAC subheader 400 has a random access ID or BI.

In a general random access response message, 0 is used as an R bit. In other words, a general terminal performs a procedure irrespective of the R fields 430 included in the random access response message. In an example embodiment of the present invention, such an R bit is used as an OI.

FIG. 5 shows a constitution of a MAC subheader of a random access response message including an OI according to an example embodiment of the present invention.

As shown in FIG. 5, a MAC subheader 500 of a random access response message according to an example embodiment of the present invention has a structural characteristic that an OI 530 is included in the position of the R fields 430 of a general random access response message.

In the example embodiment of the present invention shown in FIG. 5, an OI field 530 is composed of two bits. When the OI field 530 has a value other than 0, it means that a network is overloaded. A value of the OI field 530 may relatively express the degree of overload. For example, an overload level may be expressed as one value among 0, 1, 2 and 3 using two bits as in the example embodiment of FIG. 5.

An MTC device receiving such an overload level multiplies an OI indicating an overload level N (N≠0) by a backoff value, thereby using the resultant value as a final backoff delay value.

In brief, the constitution of a MAC subheader including an OI and the example embodiment shown in FIG. 5 in which the OI is used as a network overload state indicator may be still another important characteristic of the present invention.

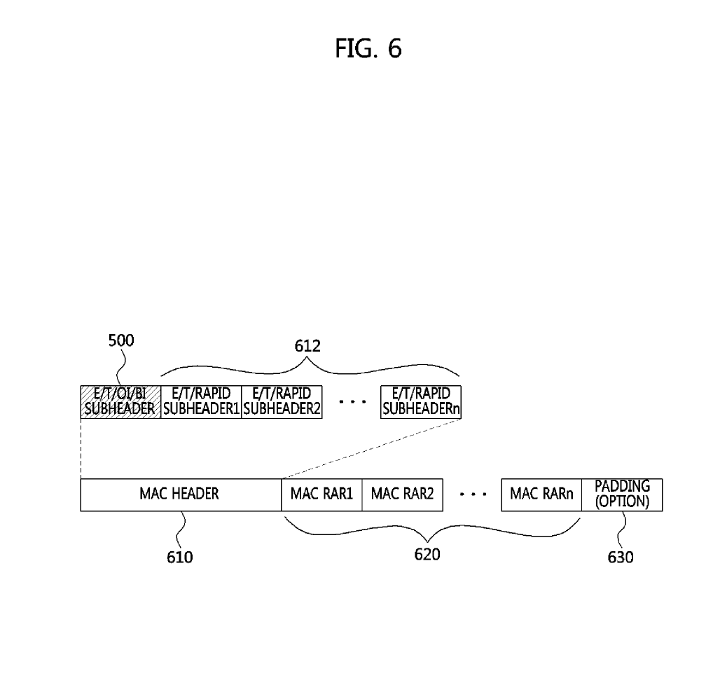

FIG. 6 shows a whole constitution of a random access response message including a MAC subheader according to an example embodiment of the present invention.

A MAC protocol data unit (PDU) constitution shown in FIG. 6 includes a MAC header 610 and MAC RARs 620 that are payload fields, and may optionally include a padding field 630. The MAC header 610 has a variable length and includes at least one MAC subheader. Each subheader other than a BI subheader corresponds to one MAC RAR.

A MAC subheader 612 may have a constitution of three header fields of E/T/RAPID, or the E/T/R/R/BI structure 400 shown in FIG. 4, that is, a BI subheader composed of five fields. Here, the RAPID field indicates an ID of a transmitted RAR.

In an example embodiment of the present invention, a MAC subheader 500 having the E/T/OI/BI structure as shown in FIG. 5, which is obtained by modifying the E/T/R/R/BI structure, is used. As described with reference to FIG. 5, the OI field 530 included in the MAC subheader 500 having the E/T/OI/BI structure includes an OI.

Thus far, an overload control apparatus and method for providing an MTC service on the basis of a 3GPP LTE-Advanced system in which a network overload state is reflected in real time according to example embodiments of the present invention have been described.

Using example embodiments of the present invention in a 3GPP LTE-Advanced system, overload in a network increased by an MTC service can be reflected in real time in a random access procedure of an MTC device, so that random access can be reduced and dispersed. Consequently, it is possible to provide a terminal with a stable service even in an overload state and reduce overload over a whole network.

While the example embodiments of the present invention and their advantages have been described in detail, it should be understood that various changes, substitutions and alterations may be made herein without departing from the scope of the invention.

What is claimed is:

1. An overload control method for a machine type communication (MTC) service in a wireless communication network, the method comprising:
when it is notified from a network that an overload state has occurred, configuring a random access response message to include an overload indicator (OI) in a media access control (MAC) subheader in the random access response message to be transmitted to a terminal by a base station, and transmitting the random access response message;
searching for a random access response message transmitted from the base station to before an MTC device wanting to perform a random access procedure transmits a random access preamble to the base station, and when the transmitted random access response message is searched for, peeking at the random access response message and receiving the random access response message; and
when it is determined that an OI is included in the peeked and received random access response message, waiting, at the MTC device, for a delay time determined based on the OI and transmitting a random access preamble for performing the random access procedure to the base station.

2. The overload control method of claim 1, wherein the delay time increases as an overload level indicated by the OI increases.

3. The overload control method of claim 1, wherein the MAC subheader further includes a backoff indicator (BI), and
the delay time increases in proportion to an overload level indicated by the OI and a backoff value indicated by the BI.

4. The overload control method of claim 1, wherein a general terminal receiving the random access response message from the base station performs a common random access procedure irrespective of the OI included in the MAC subheader in the random access response message.

5. The overload control method of claim 1, further comprising, when the base station is notified from the network that the overload state has been finished, removing, at the base station, the OI from the MAC subheader in the random access response message to be transmitted to the terminal, and transmitting the random access response message.

6. The overload control method of claim 1, wherein the base station configures the OI using reserved bits in the MAC subheader when the network is in the overload state, and
maintains the reserved bits in the MAC subheader in an original state when the network is not in the overload state.

7. The overload control method of claim 6, wherein, when the network is in the overload state, the MAC subheader includes the OI and a backoff indicator (BI).

8. A wireless communication system providing a machine type communication (MTC) service, comprising:
a base station configured to, when notified from a network that an overload state has occurred, configure a random access response message to include an overload indicator (OI) in a media access control (MAC) subheader in the random access response message to be transmitted to a terminal and transmit the random access response message; and
an MTC device configured to, before transmitting a random access preamble to the base station to perform a random access procedure, search for a random access response message transmitted from the base station, when the transmitted random access response message is searched for, peek at the random access response message and receive the random access response message, and when it is determined that an OI is included in the received random access response message, wait for a predetermined delay time and transmit the random access preamble for performing the random access procedure to the base station.

9. The wireless communication system of claim 8, further comprising a general terminal configured to receive the random access response message from the base station, and perform a common random access procedure irrespective of the OI included in the MAC subheader in the random access response message.

10. An overload control apparatus for a machine type communication (MTC) service,
wherein, when the overload control apparatus is notified from a network that an overload state has occurred, a random access response message is configured to include an overload indicator (OI) in a media access control (MAC) subheader in the random access response message to be transmitted to a terminal and is transmitted, and
when the overload control apparatus is notified from the network that the overload state has been finished, the OI is removed from the MAC subheader of the random access response message to be transmitted to the terminal, and the random access response message is transmitted.

11. The overload control apparatus of claim 10, wherein the OI is configured using reserved bits in the MAC subheader when the network is in the overload state, and
the reserved bits in the MAC subheader are maintained in an original state when the network is not in the overload state.

12. The overload control apparatus of claim 10, wherein, when the network is in the overload state, the MAC subheader includes the OI and a backoff indicator (BI).

13. A machine type communication (MTC) device communicating with a base station for an MTC service, wherein, before a random access preamble is transmitted to the base station to perform a random access procedure, a random access response message transmitted from the base station is searched for, when a transmitted random access response message is searched for, the random access response message is peeked at and received, and when it is determined that an overload indicator (OI) is included in the received random access response message, the random access preamble for performing the random access procedure is transmitted to the base station after a delay time determined based on the OI.

14. The MTC device of claim 13, wherein the delay time increases as an overload level indicated by the OI increases.

15. The MTC device of claim 13, wherein the random access response message further includes a backoff indicator (BI), and
the delay time increases in proportion to an overload level indicated by the OI and a backoff value indicated by the BI.
